(19) United States
(12) Patent Application Publication
(10) Pub. No.: US 2017/0134834 A1
(43) Pub. Date: May 11, 2017

(54) Connection Routing for a Multi-Plane Photonic Switch

(71) Applicants: Mohammad Kiaei, Ottawa (CA); Hamid Mehrvar, Ottawa (CA)

(72) Inventors: Mohammad Kiaei, Ottawa (CA); Hamid Mehrvar, Ottawa (CA)

(21) Appl. No.: 15/074,828

(22) Filed: Mar. 18, 2016

Related U.S. Application Data
(60) Provisional application No. 62/251,502, filed on Nov. 5, 2015.

(51) Int. Cl. H04Q 11/00

(52) U.S. Cl. CPC H04Q 11/0005; H04Q 11/0003

(57) ABSTRACT

Routing connections evenly through each plane of a multi-plane switch can reduce crosstalk in a switch. The routing of the connections can be parallelized in order to provide high speed routing of the connections.

### TECHNICAL FIELD

The current application relates generally to the control of photonic switches and in particular to the routing of connections through a switching fabric having multiple switching planes.

### BACKGROUND

Photonic switches provide switching between inputs and outputs to establish a photonic path for signals. The photonic switch, or simply switch for brevity, comprises a switching fabric for establishing an optical path from the inputs to the outputs in order to provide the required switching. The switching fabric may have a plurality of optical switching cells arranged in a plurality of similar switching planes. The individual switching cells may have two inputs and two outputs and can selectively switch the connections between the inputs and outputs. In addition to the photonic switching fabric, the switch may also include control logic for controlling the switching fabric in order to establish the desired connections.

Switches may be controlled in one of two broad modes. The first mode may be considered an asynchronous mode in which connection requests can be received and established at random periods. The second mode may be considered a synchronous mode in which all connection requests are established at the same time. In the synchronous mode, connections may be received at the same time, or may be received at random times; however, the routing for all available connections is done at the same time. In both the synchronous and asynchronous mode, it is possible to route the connections as they are received, however, for synchronous routing, it may require the re-routing of existing connections. In such a routing technique, the connection may be routed through the first switching plane that has the available capacity to establish the requested connection. Existing connections may be rearranged as required to establish the requested connections. For example if a connection is blocked, one or more existing connections are rearranged to allow the routing of the blocked connection. The routing of the connections in such a manner may result in an uneven number of connections being established through different ones of the switching planes.

### SUMMARY

In accordance with the present disclosure there is provided a method of routing N connections through a photonic switching fabric having P switching planes of 2ⁿ×2ⁿ switches, where P=N/n, the method comprising: routing N/P connections through a first switching plane; and repeatedly routing N/P connections selected from remaining un-routed connections through a next switching plane until all connections are routed.

In an embodiment of the method, the routing routes a single optical signal through individual switching cells of the photonic switching fabric.

In a further embodiment of the method, the routing routes a single optical signal through plane input blocks and plane output blocks, wherein each of the plane input blocks and plane output blocks comprise a 4×4 switch.

In a further embodiment of the method, the routing eliminates first order crosstalk and reduces second order cross talk of the connections.

In a further embodiment of the method, selecting and routing N/P connections for each of the first to second last switching planes comprises assigning a first connection and determining N/P−1 remaining connections possible with the assigned first connection.

In a further embodiment of the method, determining the N/P−1 remaining connections is done in parallel.

In a further embodiment of the method, determining the N/P−1 remaining connections in parallel comprises using a look-up-table of possible routings through N/P input and N/P output blocks of a 2ⁿ×2ⁿ switching plane.

In a further embodiment of the method, the first assigned connection is used to select look up table blocks, each look up table block specifying the possible routings specifies N/P−1 connections that can be routed with the first assigned connection.

In a further embodiment of the method, the possible routings specified in the look up table blocks are compared to un-routed connections to determine N/P−1 connections that can be routed.

In a further embodiment of the method, determining the N/P−1 remaining connections comprises selecting one of a plurality of look up table blocks determined to specify routings that match un-routed connections.

In a further embodiment, the method further comprises generating appropriate control signals for establishing the determined connection routings through the switching fabric.

In a further embodiment of the method, n is an integer greater than, or equal to, 3.

In accordance with the present disclosure there is provided a photonic switch comprising: N input ports; N output ports; P switching planes of 2ⁿ×2ⁿ switches for establishing optical paths between the N input ports and the N output ports, where P=N/n; and a routing controller for controlling the P switching planes to establish requested connections between the input ports and the output ports by: routing N/P connections through a first switching plane; and

repeatedly routing N/P connections selected from remaining un-routed connections through a next switching plane until all connections are routed.

In a further embodiment of the photonic switch, selecting and routing n connections for each of the first to second last switching planes comprises assigning a first connection and determining N/P−1 remaining connections possible with the assigned first connection.

In a further embodiment of the photonic switch, determining the N/P−1 remaining connections is done in parallel.

In a further embodiment of the photonic switch, determining the N/P−1 remaining connections in parallel comprises using a look-up-table of possible routings through N/P plane input blocks and N/P plane output blocks of a 2ⁿ×2ⁿ switching plane.

In a further embodiment of the photonic switch, the first assigned connection is used to select look up table blocks, each look up table block specifying the possible routings specifies N/P−1 connections that can be routed with the first assigned connection.

In a further embodiment of the photonic switch, the possible routings specified in the look up table blocks are compared to un-routed connections to determine N/P−1 connections that can be routed.

In a further embodiment of the photonic switch, determining the N/P−1 remaining connections comprises selecting one of a plurality of look up table blocks determined to specify routings that match un-routed connections.

In a further embodiment of the photonic switch, the routing of the connections eliminates 1st order crosstalk and reduces 2^{nd} order crosstalk.

In a further embodiment of the photonic switch, the routing controller further generates appropriate control signals for establishing the determined connection routings through the photonic switch.

In a further embodiment of the photonic switch, n is an integer greater than, or equal to, 3.

### BRIEF DESCRIPTION OF THE DRAWINGS

Embodiments are described herein with reference to the appended drawings, in which:

FIG. 1 depicts a multi-plane switching fabric having 4 identical switching planes;

FIG. 2 depicts details of a single switching plane of the multi-plane switching fabric of FIG. 1;

FIG. 3 depicts components of a photonic switch;

FIG. 4 is a flow chart of a method of routing connections through a multi-plane switching fabric;

FIG. 5 is a flow chart of a method of routing n connections through a single plane of a multi-plane switching fabric;

FIG. 6 is a flow chart of a method of routing 16 connections through a 4-plane switching fabric;

FIG. 7 depicts established connections through a first switching plane of a 4-plane switching fabric;

FIG. 8 depicts schematically determination of connections through a switching plane; and

FIG. 9 depicts a multi-plane switching fabric having 8 identical switching planes.

### DETAILED DESCRIPTION

The synchronous, or parallel, routing of connections through a multi-plane photonic switching fabric may reduce possible crosstalk by distributing requested connections evenly through each of the planes of the switching fabric. By routing connections evenly through each of the switching planes it may be possible, depending on the particular architecture of the switching fabric, to eliminate first order crosstalk and reduce 2^{nd} order crosstalk of the signals. Further, the computation of the routing may be partially parallelized resulting in improved performance of the connection routing. Accordingly, the routing technique described further below can provide high-speed routing of connection through multi-plane switching fabrics while providing a routing that eliminates 1^{st} order crosstalk and reduces 2^{nd} order crosstalk. The connection routing described below may be used when operating the switching fabric in a synchronous mode so that all requested connections are established substantially at the same time.

The connection routing is described in detail below with respect to a 16×16 switching fabric that uses 4 identical switching planes, with each switching plane comprising a 16×16 switch capable of establishing connections between 16 plane inputs and 16 plane outputs. Although described in detail with respect to a single switching architecture, it will be appreciated that the routing may be applied to other architectures, and in particular to N×N switch architectures having P identical switching planes each capable of establishing connections between 2ⁿ plane inputs and 2ⁿ plane outputs, where P=N/n. As described in detail further below, the switching planes are assumed to be 16×16 switches, however, larger sized switching planes are possible.

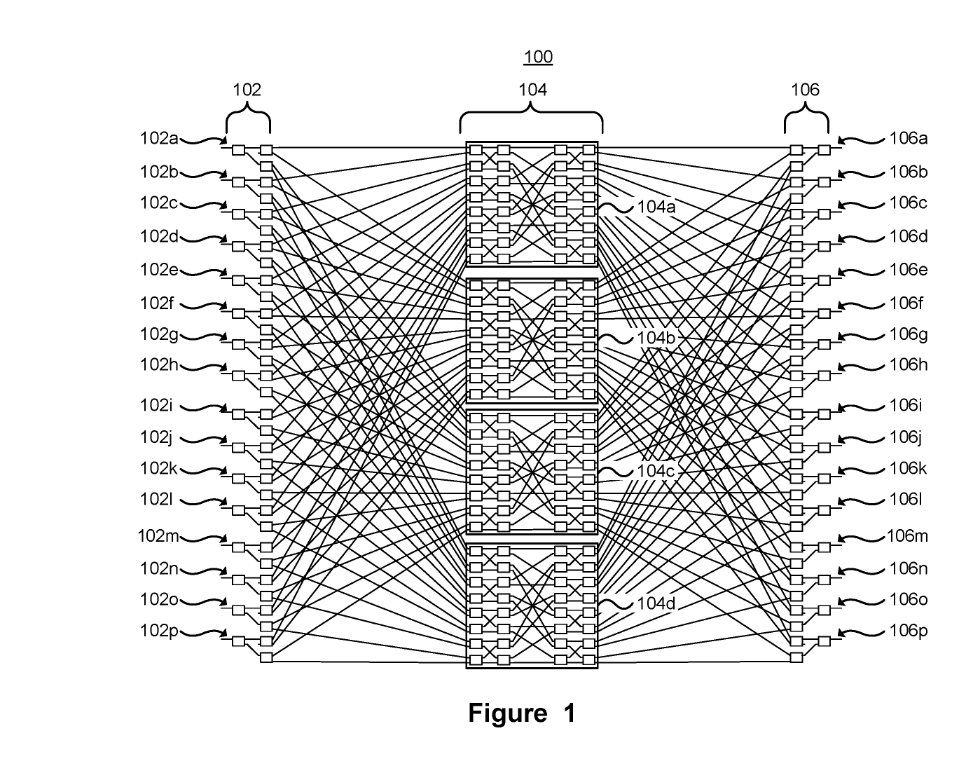

FIG. 1 depicts a multi-plane switching fabric 100 having 4 identical switching planes. The switching fabric 100 is a rearrangeably non-blocking (RNB) 16×16 fabric. The connection routing described further below can provide synchronous connection routing for the switching fabric 100 while ensuring only a single optical signal is switched by each individual switching cell in order to eliminate first order crosstalk. Further, the connection routing may route a single optical signal through plan input blocks and plane output blocks comprising a group of 4 switching cells arranged as a 4×4 switch. By routing only a single optical signal through each plane input and output blocks second order crosstalk may be reduced. As depicted, the switching fabric 100 comprises an input section 102 comprising a plurality of individual inputs 102a-102p, a switching core 104 comprising a plurality of switching planes 104a-104d capable of establishing connections between the individual inputs of the input section 102 and an output section 106 comprising a plurality of individual outputs 106a-106p. Each individual photonic switching cell, depicted schematically by the smallest rectangles in FIG. 1, provides a 2×2 cross-bar switch for optical signals. The individual switching cells may be provided, for example, by a Mach-Zehnder interferometer (MZI) switching cell, which allows for the electrically-controlled optical switching of the optical signals.

As depicted in FIG. 1, the switching fabric 100 comprises 16 individual inputs 102a-102p. Each input comprises 3 switching cells arranged to fan-out the input signal in order to connect each individual input signal to each of the switching planes 104a-104d. As can be seen, the switching cells of the input section 102 are 1×2 switching cells, thus allowing a single input to be switched to any of the four planes 104. Although illustrated as 1×2 switching cells those skilled in the art will appreciate that a 1×2 switching cell can be replaced by a 2×2 switching cell with either one of the inputs receiving no signal or controlled to ensure that only one input is considered. Other arrangements that allow a single input to be routed to 4, or P, different destinations can be used without departing from the current teachings. Similarly, each of the 16 individual outputs 106a-106p comprises 3 switching cells arranged to fan-in output signals from each of the switching planes 104a-104d to the individual outputs. As discussed above, with respect to the input, any arrangement that allows a sufficient fan-in can be used. As depicted in FIG. 1, each of the individual inputs 102a-102p and outputs 106a-106p are connected to the same plane input and plane output blocks in each of the individual switching planes 104a-104d. For example, input 102a is connected to the top-most plane input block of each of the switching planes 104a-104d.

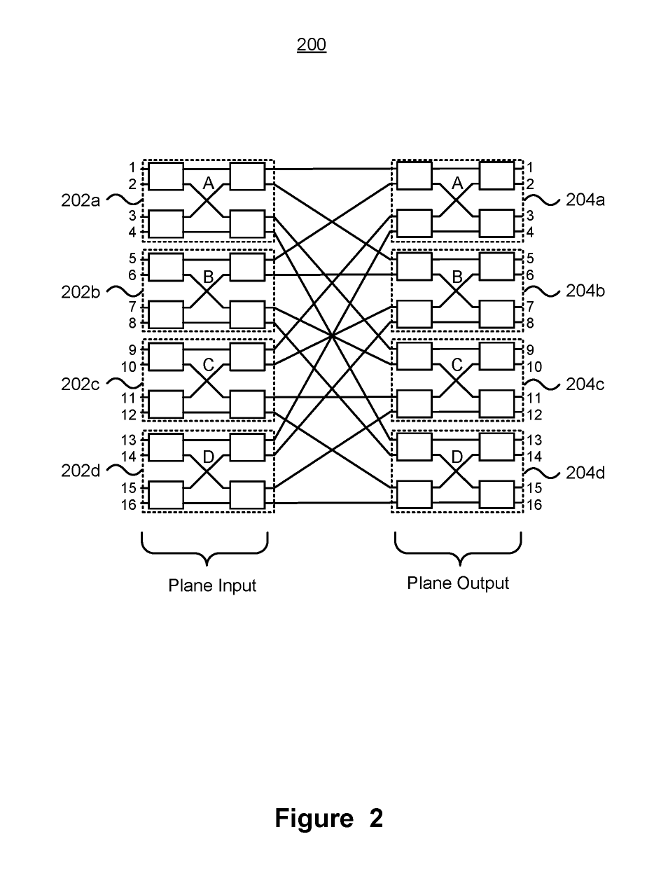

FIG. 2 depicts details of a single switching plane 200 of the multi-plane switching fabric 100 of FIG. 1. The switching plane 200 of FIG. 2 may be used as each of the individual switching planes 104a-104d described above with reference to FIG. 1. The switching plane 200 of FIG. 2 comprises 4 plane input blocks 202a-202d (referred to collectively as plane input blocks 202) and 4 plane output blocks 204a-204d (referred to collectively as plane output blocks 204). Each of the plane input blocks 202 and plane output blocks 204 are provided by 4 individual switching cells arranged to provide a 4×4 switch. Each of the plane input blocks 202 are connected to 4 particular inputs of the switching fabric 100 as depicted in FIG. 1. Similarly, each of the plane output blocks 204 of FIG. 2 are connected to 4 particular outputs of the switching fabric 100 of FIG. 1. That is, plane input block A, 202a, is connected to input signals 1, 2, 3 and 4, (FIG. 2) which can be routed from the inputs 102a-102d of the switching fabric 100 (FIG. 1). Plane input block B, 202b, is connected to input signals 5, 6, 7, and 8, which can be routed from the inputs 102e-102h of the switching fabric 100. Plane input block C, 202c, is connected to input signals 9, 10, 11 and 12 which can be routed from the inputs 102i-l of the switching fabric 100. Plane input block D, 202d, is connected to input signals 13, 14, 15 and 16, which can be routed from the inputs 102m-p of the switching fabric 100. The plane output blocks 204 are similarly connected to respective outputs of the switching fabric 100.

The plane input blocks 202 and plane output blocks may each be provided by a 2×2 array of 2×2 switching cells. The individual 2×2 switching cells may be provided by a Mach-Zehnder interferometer (MZI) switch. The first column of switching cells of the plane input blocks 202 receives the input signals (in the case of 202a, input signals 1-4), and is connected so that each of the two cells of the first column can route signals to either of the 2×2 switching cells in the second column. The outputs of an plane input block are fed to inputs of each of the plane output blocks 204 in the plane output of the switching plane. The internal structure of the plane output blocks 204 is similar to that of the plane input blocks 202. Each of the plane output blocks 204 receives, as an input, one output signal from each of the plane input blocks 202. For example, plane output block 204a receives an output signal from each of the plane input blocks 202a, 202b, 202c, 202d.

Returning to FIG. 1, it is possible to establish 16 connections through the 4 switching planes 104a-104d. By evenly distributing the connections among the 4 switching planes 104a-104d it may be possible to have a single optical signal connected through each plane input block and plane output block. That is, with 16 connections and 4 switching planes, each switching plane may establish 4 connections. If each of the switching planes 104 has a similar structure to that of FIG. 2, each of the 4 connections established through a switching plane 104 may be established through an individual plane input block and an individual plane output block. Routing only a single connection through a plane input block and plane output block eliminates possible 1^{st} order crosstalk and can reduce the 2^{nd} order crosstalk to a maximum of 3 other aggressor connections. These connections have a maximum of 3 individual switching cells whose un-used output port is connected to a victim connection switching cell. Although described as reducing the 2^{nd} order crosstalk to a maximum of 3 other aggressor connections, the amount of crosstalk may be reduced to a threshold number of aggressor connections. The threshold number may be based on a number of factors including, for example, the number of connections that the switch can establish.

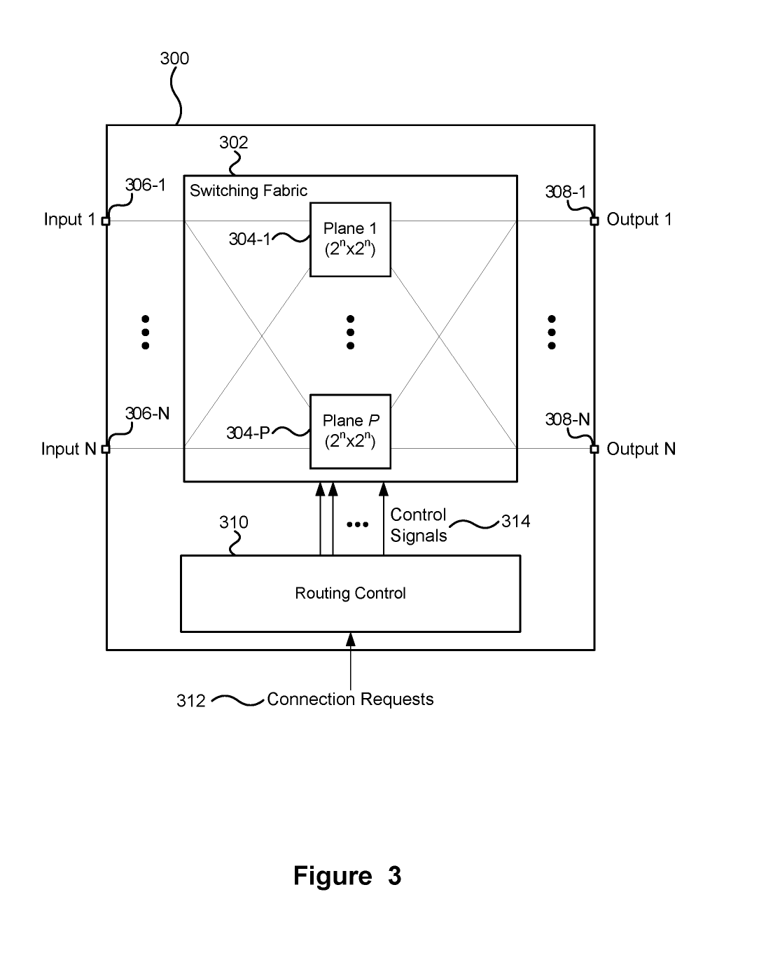

FIG. 3 depicts components of a photonic switch 300. The photonic switch 300 comprises a multi-plane switching fabric 302, such as the switching fabric 100 described above. The switching fabric 302 comprises P switching planes 304-1-304-P. The switch 300 comprises N input ports 306-1-306-N and N output ports 308-1-308-N. Each of the P switching planes may provide m connections where m=2ⁿ. The number of switching planes P is determined according to P=N/n. For example, for a 16×16 switch, N=16 and using 16×16 switching planes, m=16 and n=4. The number of switching planes is required is P=4. Each of the switching planes may be provided by a plurality of plane input blocks and plane output blocks as depicted in FIG. 2. The switching fabric 302 is connected between the input ports and output ports by, for example, optical waveguides. The switching fabric 302 may be provided as a photonic integrated circuit (PIC). The switching fabric 302 is controlled by electrical control signals 314 that are generated by routing control logic 310. The routing control logic 310 may be implemented in a number of different ways including as an Application Specific Integrated Circuit (ASIC), in a Field Programmable Gate Array (FPGA), using a programmable microcontroller or general purpose processor etc. Regardless of the particular implementation, the routing control logic 310 receives the connection requests 312, determines the connection routing through the switching fabric and generates the appropriate control signals 314 in order to establish the requested connections through the switch.

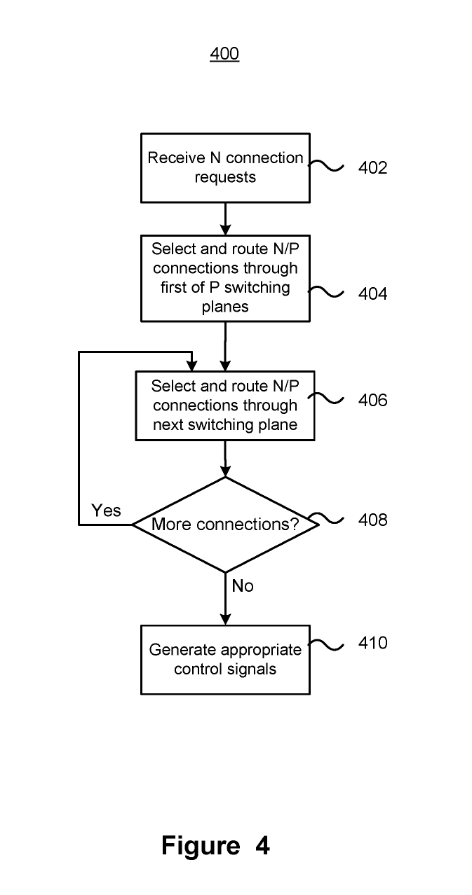

FIG. 4 is a flow chart of a method 400 of routing connections through a multi-plane switching fabric. The routing method 400 may be provided by routing control logic of a switch, such as routing control logic 310 described above. The method 400 ensures that all of the N connections are routed through the P=N/n planes that are each capable of establishing m=2ⁿ connections. The routing evenly distributes the N connections across each of the P switching planes. With the connections routed evenly through the switching planes, each plane input block and plane output block only route a single connection. The method 400 may be applied to N×N switches comprising P=N/n identical, or similar, switching planes. Each of the switching planes may include m=2ⁿ plane inputs and m=2ⁿ plane outputs each connected to respective inputs and outputs of the switch fabric. Each switching plane may include a plurality of 4×4 plane input blocks connected to a plurality of 4×4 plane output blocks. The method 400 receives all N connection requests, although fewer than N connections may be received, at a step 402. The routing operates in a synchronous mode in which all of the received connections may be established substantially at the same time. Accordingly, all of the requested connections are available when determining a connection routing. Once the connection requests are received, N/P connections are routed through a first one of the P switching planes at a step 404. The selection of the connections to route through the first plane may be done so that each plane input block and plane output block establishes only one connection out of a possible 24 possible connections. Once the N/P connections are routed through the first plane, N/P connections from the remaining un-routed connections may be selected and routed through the next plane at a step 406. Again, the N/P connections are selected so that only a single connection is routed through each of the plane input and plane output blocks. The method may determine if there are more connections to route at a step 408 and if there are (Yes at step 408), another N/P connections are selected and routed through the next switching plane at a step 406. If there are no more connections to route the method may generate the appropriate control signals at a step 410 for establishing the routed connections through the switching fabric. It is to be understood that the signal path selection steps may be done in advance, and physical routing steps may be performed substantially simultaneously, and/or successively. For synchronous operation of an optical switching fabric, establishment of all the required connections and corresponding optical switch states is completed by the time a new synchronous frame begins.

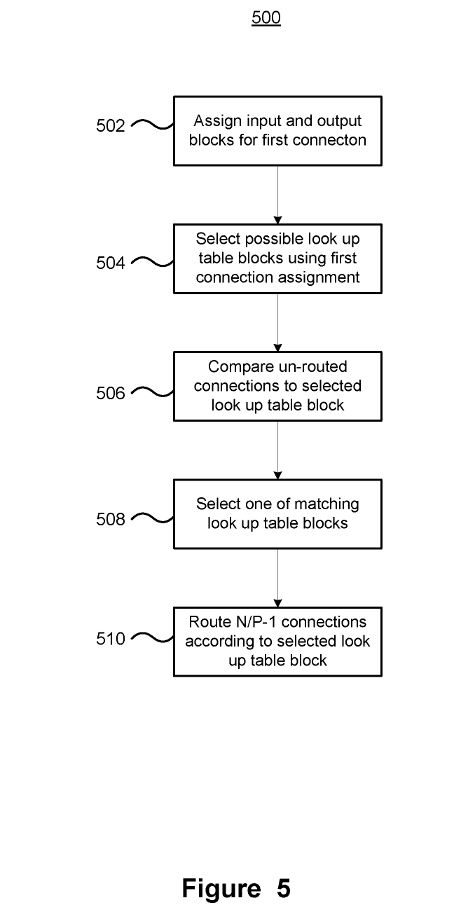

FIG. 5 is a flow chart of a method 500 of routing N/P connections through a single plane of a multi-plane switching fabric. The method 500 may be used in routing N/P connections through the first plane 104a as well as through the remaining planes 104b, c, d of the optical switching fabric 100 of FIG. 1, in accordance with the method 400 described above with reference to FIG. 4. The method 500 of FIG. 5 first assigns input and output blocks to a first one of the N/P connections at a step 502. The input and output block assignment is used in selecting a plurality of look up table blocks that specify possible connections at a step 504. As an example, if the first connection is routed through a first input block, any look up table blocks that route a connection through the first input block can be omitted since it is already routing a connection and as such should not be considered for routing further connections. The connections specified in the selected look up table blocks are compared to the un-routed connections to determine the look up table blocks that match requested connections at a step 506. One or more of the look up table blocks that match the un-routed connections is selected at a step 508. The selected look up table block is used to route N/P−1 of the connections at a step 510. The look up table blocks specifies connections that can be routed through the switch while the un-routed connections specify the requested connections that need to be established. Accordingly, by matching the un-routed connections to possible connections, the routing can determine N/P−1 connections simultaneously.

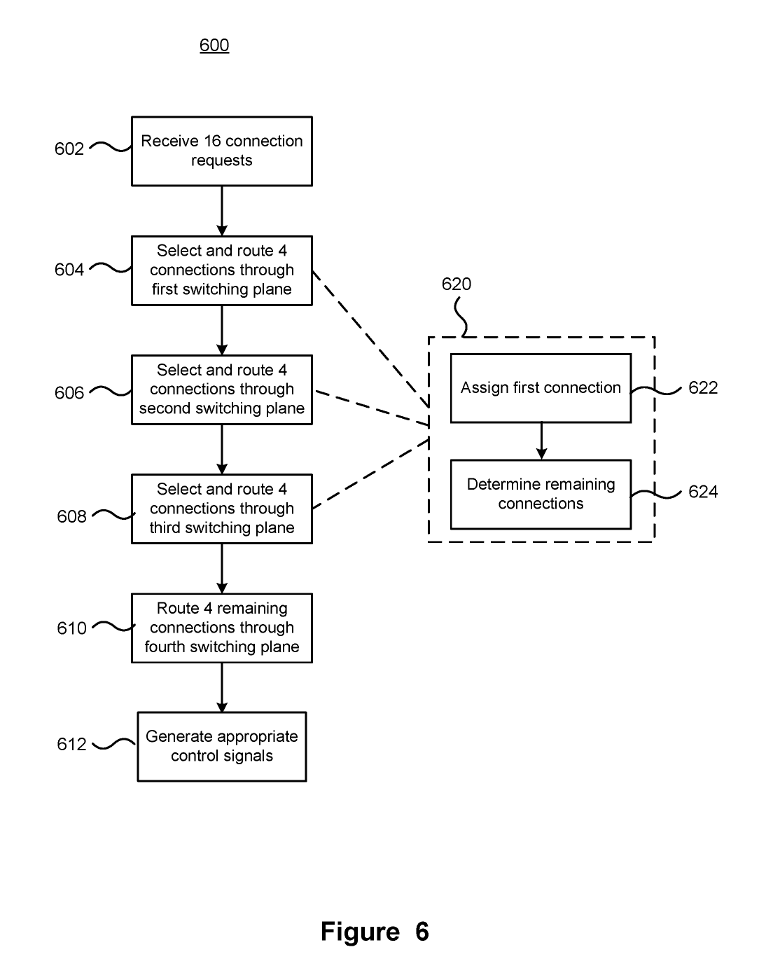

FIG. 6 is a flow chart of a method 600 of routing 16 connections through a 4-plane switching fabric such as, for example, the optical switching fabric 100 of FIG. 1. The method 600 of FIG. 6 will be described with reference to Table 1, which depicts a particular set of connection requests between 16 inputs and 16 outputs of the switching fabric 100. Table 1 also depicts the particular plane input block and plane output block used by each connection as well as the particular switching plane the connection is routed through. Table 1 also depicts the particular routing step at which the plane selection is determined as well as an amount of 2^{nd} order crosstalk at the output as a result of the completed routing.

The method 600 begins with receiving the 16 connection requests at a step 602, which specify which output should be connected to which input. Looking at Table 1, it can be seen that input 1 should be connected to output 12, input 2, should be connected to output 11 etc. As depicted in FIG. 2, each switching plane may have a number of individual plane input blocks 202 and plane output blocks 204 and each of the blocks are associated with 4 respective inputs and outputs. Accordingly, inputs 1 through 4 will be routed through the ‘A’ plane input blocks of each of the 4 switching planes. Inputs 5 though 8 will be routed through the ‘B’ plane input blocks of each of the 4 switching planes. Inputs 9 through 12 will be routed through the ‘C’ plane input blocks of each of the 4 switching planes. Inputs 13 through 16 will be routed through the ‘D’ plane input blocks of each of the 4 switching planes. Similarly, outputs 1 through 4 will be routed through the ‘A’ plane output blocks of each of the 4 switching planes. Outputs 5 though 8 will be routed through the ‘B’ plane output blocks of each of the 4 switching planes. Outputs 9 through 12 will be routed through the ‘C’ plane output blocks of each of the 4 switching planes. Outputs 13 through 16 will be routed through the ‘D’ plane output blocks of each of the 4 switching planes. The routing process selects the switching planes for the connections so that each of the plane input and plane output blocks only route a single connection.

Once the connections are received, 4 connections are selected and routed through the first switching plane at a step 604. Once the connections are routed through the first plane, 4 more connections from the un-routed connections are selected and routed through the second switching plane at a step 606. Once the connections are routed through the second plane, 4 more connections from the un-routed connections are selected and routed through the third switching plane at a step 608. The remaining 4 connections are then routed through the fourth switching plane at a step 610. Once all of the connections have been routed, the appropriate control signals are generated at a step 612 in order to establish the routed connections in the switching fabric.

The selection and routing of the connections through the first three switching planes may be a two-part process depicted as block 620. The process 620 assigns a first connection to the switching plane at a step 622 and then determines the remaining connections at a step 624 that can be routed through the same plane. It is noted that the same process could be applied to the fourth switching plane; however, there are only 4 remaining un-routed connections and as such selection of the particular connections is not necessary.

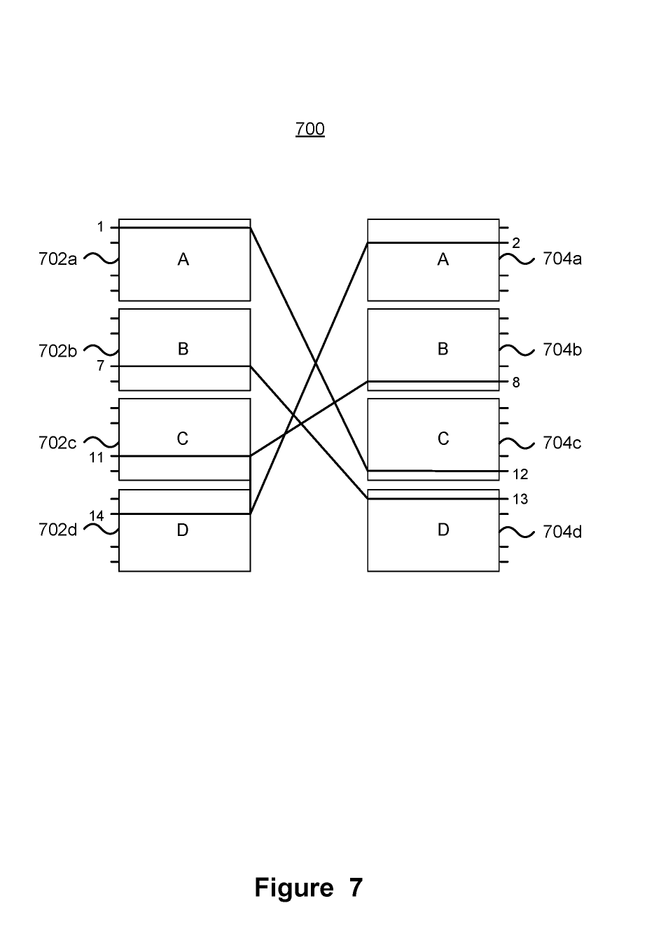

FIG. 7 depicts established connections through a first switching plane 700 of a 4-plane switching fabric such as, for example, the optical switching fabric 100 of FIG. 1. The switching plane 700 of FIG. 7 establishes a single connection through each of the plane input blocks 702a-702d and plane output blocks 704a-704d. In particular the connection between input 1 and output 12 is routed through plane input block A and plane output block C. The connection between input 7 and output 13 is routed through plane input block B and plane output block D. The connection between input 11 and output 8 is routed through plane input block C and plane output block B. The connection between input 14 and output 2 is routed through plane input block D and plane output block A.

TABLE 1
Table showing routing of connections

| | | Plane | Plane | | | |
|---|---|---|---|---|---|---|
| | | Input- | Output- | Switching | Routing | 2^{nd} Order |
| Input | Output | block | block | Plane | Step | crosstalk |
| 1 | 12 | A | C | Plane 1 | 1a | 3x |
| 2 | 11 | A | C | Plane 2 | 2a | 2x |
| 3 | 16 | A | D | Plane 3 | 3a | 1x |
| 4 | 6 | A | B | Plane 4 | 4a | 3x |
| 5 | 1 | B | A | Plane 2 | 2b | 1x |
| 6 | 9 | B | C | Plane 3 | 3b | 2x |
| 7 | 13 | B | D | Plane 1 | 1b | 1x |
| 8 | 4 | B | A | Plane 4 | 4b | 2x |
| 9 | 3 | C | C | Plane 4 | 4b | 3x |
| 10 | 3 | C | A | Plane 3 | 3b | 3x |
| 11 | 8 | C | B | Plane 1 | 1b | 3x |
| 12 | 7 | C | A | Plane 2 | 2b | 2x |
| 13 | 14 | D | D | Plane 4 | 4b | 1x |
| 14 | 2 | D | A | Plane 1 | 1b | 2x |
| 15 | 5 | D | B | Plane 3 | 3b | 2x |
| 16 | 15 | D | D | Plane 2 | 2b | 1x |

Although the above has described that the selection and routing of the four connections of a particular switching plane is done in the same routing step, it is possible for the initial assignment of all four planes to be done in one step. Looking at Table 1, it is clear that the first inputs, namely 1, 2, 3 and 4 will need to be routed through different planes since they are all routed through the ‘A’ plane input block. Accordingly, rather than assigning the connections to particular planes in different routing steps, such as steps 1a, 2a, 3a, and 4a as depicted in Table 1, the initial plane assignments can be made in a single step. That is, steps 1a, 2a, 3a, and 4a depicted in Table 1 may be accomplished in a single step. Further, as depicted in Table 1, the additional 3 connections to route through each plane may determined in a single step for each plane, indicated as steps 1b, 2b, 3b, 4b. It is noted that the determination of the connections for the fourth plane may simply be a selection of the remaining 3 un-routed connections.

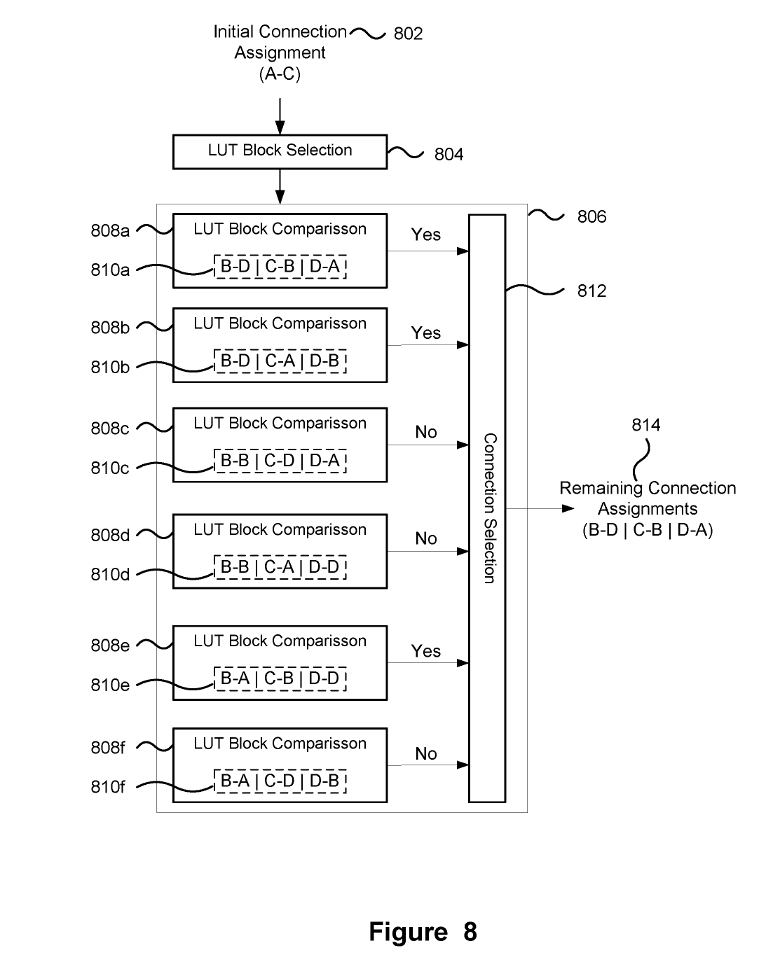

FIG. 8 depicts schematically a process for the determination of connections through a switching plane. The depicted process utilizes parallel comparisons of look-up-table (LUT) values to determine which of the remaining un-routed requests may be established in through the switching plane. The LUT provides a list of all possible connections between plane input blocks and plane output blocks. Table 2 depicts an example LUT. As depicted, there are 24 possible connections that can be routed through the 4 plane input blocks (‘A’, ‘B’, ‘C’, ‘D’) and the 4 plane output blocks (‘A’, ‘B’, ‘C’, ‘D’). The first row, not including the header row, in Table 2 indicates that 4 allowable connections through a plane are: A-D, B-C, C-B, D-A.

TABLE 2
Table of possible connections between input and output blocks

| Plane Input Blocks | | | | Plane Output Blocks | | | |
|---|---|---|---|---|---|---|---|
| A | B | C | D | D | C | B | A |
| A | B | C | D | D | C | A | B |
| A | B | C | D | D | B | C | A |
| A | B | C | D | D | B | A | C |
| A | B | C | D | D | A | B | C |
| A | B | C | D | D | A | C | B |
| A | B | C | D | C | D | B | A |
| A | B | C | D | C | D | A | B |
| A | B | C | D | C | B | D | A |
| A | B | C | D | C | B | A | D |
| A | B | C | D | C | A | B | D |
| A | B | C | D | C | A | D | B |
| A | B | C | D | B | C | D | A |
| A | B | C | D | B | C | A | D |
| A | B | C | D | B | D | C | A |
| A | B | C | D | B | D | A | C |
| A | B | C | D | B | A | D | C |
| A | B | C | D | B | A | C | D |
| A | B | C | D | A | C | B | D |
| A | B | C | D | A | C | D | B |
| A | B | C | D | A | B | C | D |
| A | B | C | D | A | B | D | C |
| A | B | C | D | A | D | B | C |
| A | B | C | D | A | D | C | B |

Turning to FIG. 8, an initial connection assignment 802 is received and used at a step 804 to select a particular block of the LUT. In the example connection requests of Table 1, and assuming that the connection selection is for the first plane, the initial connection assignment would be a connection between input 1 and output 12, which maps to a connection between plane input block ‘A’ and plane output block ‘C’. This initial connection assignment is used to select particular rows of the LUT. The particular rows that are selected are the rows of the LUT in which plane input block ‘A’ is connected to plane output block ‘C’. In Table 2 this corresponds to rows 7 through 12. The selected rows of the LUT indicate that allowable connections that can be established. Each of the six possible connection arrangements can be checked in parallel at a step 806 in order to determine the remaining 3 connections 814. As depicted, 6 LUT block comparisons 808a-808f may be made in parallel in order to select which of the un-routed connections can be established. Each of the LUT comparisons 808a-808f compares allowable connections from a particular row 810a-810f of the selected LUT block to available un-routed connections. For example, the first LUT block comparison determines if there exists un-routed connections from ‘B’ to ‘D’ and ‘C’ to ‘B’ and ‘D’ to ‘A’. In the example of Table 1, these connections do exist and as such the comparison is successful and the located connections can be established through the plane. The output of the LUT comparisons are depicted as being Yes if the connections from the LUT row can be established or No if the connections from the LUT row cannot be established. Although depicted as Yes and No, the comparison may provide an indication of the particular connection requests that were determined as being possible. As depicted, all of the possible rows of the selected LUT block are processed in parallel and as such, multiple sets of connections may be possible. One set of connections may be selected at a step 812 for the remaining connection assignments. In FIG. 7, the selected connection assignment for the remaining 3 connections of switching plane 1 correspond to the first LUT block comparison, namely input 7 to output 13, input 11 to output 8 and input 14 to output 2.

The routing technique was tested in a simulation by routing 200 million random 16×16 connection maps. No blocking occurred for all 200 million connection maps. The routing technique described above provides parallel routing of connections in synchronous mode. The routing technique can provide fast routing of connections with zero blocking with low, or no, rearrangement through multi-plane switching fabrics. In addition to providing fast route calculations, the resulting connection routes provide low crosstalk at the outputs. In particular, first order crosstalk can be completely avoided and second order crosstalk can be reduced to a maximum of 3 other aggressor connections.

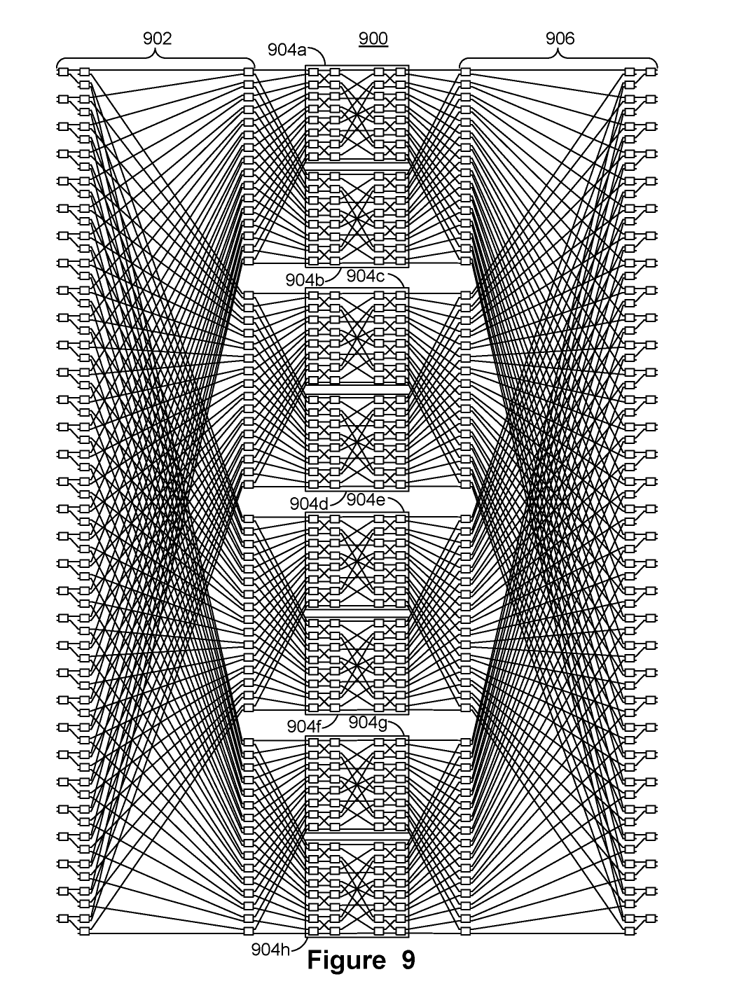

FIG. 9 depicts a multi-plane switching fabric 900 having 8 identical switching planes. The multi-plane switching fabric 900 comprises a fan-in section 902 comprising a plurality of individual switches for selectively coupling each one of 32 inputs to each one of the plurality of switching planes 904a-904h (referred to collectively as switching planes 904). Each of the switching planes 904 is coupled to each one of 32 outputs through a fan-out section 906 comprising a plurality of individual switches that selectively couple plane outputs from the switching planes 904 to the outputs of the switching fabric. Each of the switching planes 904 comprises a 16×16 switch arranged as a column of 4 plane input blocks connected to a column of 4 plane output blocks. Routing of the connections through the multi-plane switching fabric 900 proceeds according to the multi-plane routing described above.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A method of routing N connections through a photonic switching fabric having P switching planes of 2ⁿ×2ⁿ switches, where P=N/n, the method comprising:
routing N/P connections through a first switching plane; and
repeatedly routing N/P connections selected from remaining un-routed connections through a next switching plane until all connections are routed.

2. The method of claim 1, wherein the routing routes a single optical signal through individual switching cells of the photonic switching fabric.

3. The method of claim 2, wherein the routing routes a single optical signal through plane input blocks and plane output blocks, wherein each of the plane input blocks and plane output blocks comprise a 4×4 switch.

4. The method of claim 3, wherein the routing eliminates first order crosstalk and reduces second order cross talk of the connections.

5. The method of claim 1, wherein selecting and routing N/P connections for each of the first to second last switching planes comprises assigning a first connection and determining N/P−1 remaining connections possible with the assigned first connection.

6. The method of claim 5, wherein determining the N/P−1 remaining connections is done in parallel.

7. The method of claim 6, wherein determining the N/P−1 remaining connections in parallel comprises using a look-up-table of possible routings through N/P input and N/P output blocks of a 2ⁿ×2ⁿ switching plane.

8. The method of claim 7, wherein the first assigned connection is used to select look up table blocks, each look up table block specifying the possible routings specifies N/P−1 connections that can be routed with the first assigned connection.

9. The method of claim 8, wherein the possible routings specified in the look up table blocks are compared to un-routed connections to determine N/P−1 connections that can be routed.

10. The method of claim 9, wherein determining the N/P−1 remaining connections comprises selecting one of a plurality of look up table blocks determined to specify routings that match un-routed connections.

11. The method of claim 1, further comprising generating appropriate control signals for establishing the determined connection routings through the switching fabric.

12. The method of claim 1, wherein n is an integer greater than, or equal to, 3.

13. A photonic switch comprising:
N input ports;
N output ports;
P switching planes of 2ⁿ×2ⁿ switches for establishing optical paths between the N input ports and the N output ports, where P=N/n; and
a routing controller for controlling the P switching planes to establish requested connections between the input ports and the output ports by:
routing N/P connections through a first switching plane; and
repeatedly routing N/P connections selected from remaining un-routed connections through a next switching plane until all connections are routed.

14. The photonic switch of claim 13, wherein selecting and routing n connections for each of the first to second last switching planes comprises assigning a first connection and determining N/P−1 remaining connections possible with the assigned first connection.

15. The photonic switch of claim 14, wherein determining the N/P−1 remaining connections is done in parallel.

16. The photonic switch of claim 15, wherein determining the N/P−1 remaining connections in parallel comprises using a look-up-table of possible routings through N/P plane input blocks and N/P plane output blocks of a 2ⁿ×2ⁿ switching plane.

17. The photonic switch of claim 16, wherein the first assigned connection is used to select look up table blocks, each look up table block specifying the possible routings specifies N/P−1 connections that can be routed with the first assigned connection.

18. The photonic switch of claim 17, wherein the possible routings specified in the look up table blocks are compared to un-routed connections to determine N/P−1 connections that can be routed.

19. The photonic switch of claim 18, wherein determining the N/P−1 remaining connections comprises selecting one of a plurality of look up table blocks determined to specify routings that match un-routed connections.

20. The photonic switch of claim 13, wherein the routing of the connections eliminates 1^{st} order crosstalk and reduces 2^{nd} order crosstalk.

21. The photonic switch of claim 13, wherein the routing controller further generates appropriate control signals for establishing the determined connection routings through the photonic switch.

22. The photonic switch of claim 13, wherein n is an integer greater than, or equal to, 3.
